(19) United States
(12) Patent Application Publication
(10) Pub. No.: US 2008/0135078 A1
(43) Pub. Date: Jun. 12, 2008

(54) Brace for a walker

(75) Inventor: Chang-Ting Hsieh, Taoyuan Hsien (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: Q.S. CONTROL CORP., Taoyuan Hsien (TW)

(21) Appl. No.: 11/636,253

(22) Filed: Dec. 8, 2006

(51) Int. Cl. A61H 3/00

(52) U.S. Cl. 135/67

(57) ABSTRACT

A brace for a walker has a body and two mounting clamps. The body has two ends and an internal cavity a through hole. The internal cavity is defined longitudinally in the body. The mounting clamps are cylindrical, are formed respectively on and protrude longitudinally respectively from the ends of the body, are mounted respectively around the legs, and each mounting bracket has a longitudinal mounting slot, an inner surface, multiple mounting posts and multiple mounting recesses. The longitudinal mounting slot is formed diametrically opposite to the end of the body. The mounting posts are formed on the inner surface of the mounting bracket. The mounting recesses are formed in the inner surface of the mounting bracket.

### BACKGROUND OF THE INVENTION

1. Field of the Invention

The present invention relates to a brace, and more particularly to a brace used to support a walker.

2. Description of Related Art

With reference to FIG. 5, a conventional walker in accordance with the prior art is tubular and metal and has two side frames (30) and two crossbars (40).

With further reference to FIG. 6, each side frame (30) is U-shaped and has a handrail (32), two legs (31), a grip (33) and a brace (35, 50). The handrail (32) has two ends. The legs (31) are formed respectively on and protrude down parallel to each other respectively from the ends of the handrail (32). Each leg (31) has an upper end and a lower end. The upper end of the leg (31) is formed on one end of the handrail (32). The grip (33) is mounted around the handrail (32) between the two ends.

The brace (35, 50) may be metal or plastic, is connected securely to the legs (31) between the upper ends and the lower ends of the legs (31) parallel to the handrail (32) to increase the strength of the side bracket (30).

The metal brace (35) may be a solid rod or tubular and has two ends. The ends of the metal brace (35) are concave to conform respectively to the legs (31) and are welded respectively to the legs (31).

The plastic brace (50) is significantly lighter than the metal brace (35) and has a body (51) and a cover (52).

The body (51) is hollow, is attached to the legs (31) and has two ends, an internal cavity, two mounting clamps (510), an open bottom (511) and multiple connecting partitions. The mounting clamps (510) are formed respectively on and protrude longitudinally from the ends of the body (51) and are mounted respectively around the legs (31). The open bottom (511) communicates with the internal cavity. The connecting partitions are mounted in the internal cavity of the body (51) and each connecting partition has a connecting post (512) protruding out of the open bottom (511) of the body (51).

The cover (52) is connected to the body (51), covers the open bottom (511), may be bonded to the body (51) with an adhesive and has multiple through holes (520). The through holes (520) are formed through the cover (52) and correspond respectively to and are mounted respectively around the connecting posts (512) to connect the cover (52) to the body (51).

The crossbars (40) are connected securely to the side frames (30). One of the crossbars (40) is connected to the handrails (32) of the side frames (30) in front of the grips (33). The other crossbar (40) is connected to the legs (31) between the handrails (32) and the braces (35) below the crossbar (40) connected to the handrails (32).

The braces (35, 50) as described have the following shortcomings.

The metal brace (35) causes the walker to be heavy and inconvenient to use. Furthermore, since the metal brace (35) is welded, the metal brace (35) must be cleaned and painted after welding to keep the metal brace (35) from rusting. This will increase the cost and time for manufacturing the walker. Furthermore, manually welding the metal brace (35) to the legs (31) may result in weak joints between the metal brace (35) and the legs (31).

Fabrication of the plastic brace (50) requires that the cover (52) be fitted on the protrusion (512) on the division walls and bonded to the body (51). This process can be tedious and time consuming, which increases the cost of manufacturing the plastic brace (50). The brace for a walker in accordance with the present invention mitigates or obviates the aforementioned problems.

### SUMMARY OF THE INVENTION

The main objective of the present invention is to provide a brace for a walker, which is strong and lightweight and can be manufactured quickly and easily.

The brace for a walker has a body and two mounting clamps. The body has two ends and an internal cavity. The internal cavity is defined longitudinally in the body. The mounting clamps are cylindrical, are formed respectively on and protrude longitudinally respectively from the ends of the body and are mounted respectively around the legs, and each mounting clamp has a longitudinal mounting slot, an inner surface, multiple mounting posts and multiple mounting recesses. The longitudinal mounting slot is formed diametrically opposite to the end of the body. The mounting posts are formed on the inner surface of the mounting bracket. The mounting recesses are formed in the inner surface of the mounting bracket.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a walker with two braces in accordance with the present invention;

FIG. 2 is a perspective view of a brace in FIG. 1;

FIG. 3 is a cross sectional side view of the brace in FIG. 2;

FIG. 4 is a cross section side view of a second embodiment of a brace in accordance with the present invention;

FIG. 5 is a perspective view of a walker with a conventional metal brace in accordance with the prior art; and

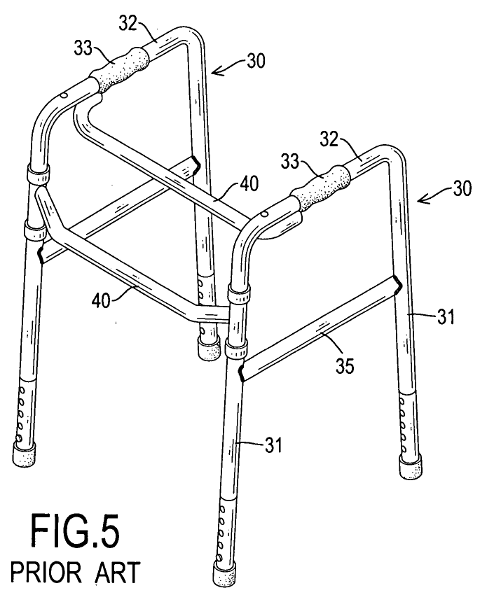

FIG. 6 is a perspective view of a walker with a conventional plastic brace in accordance with the prior art.

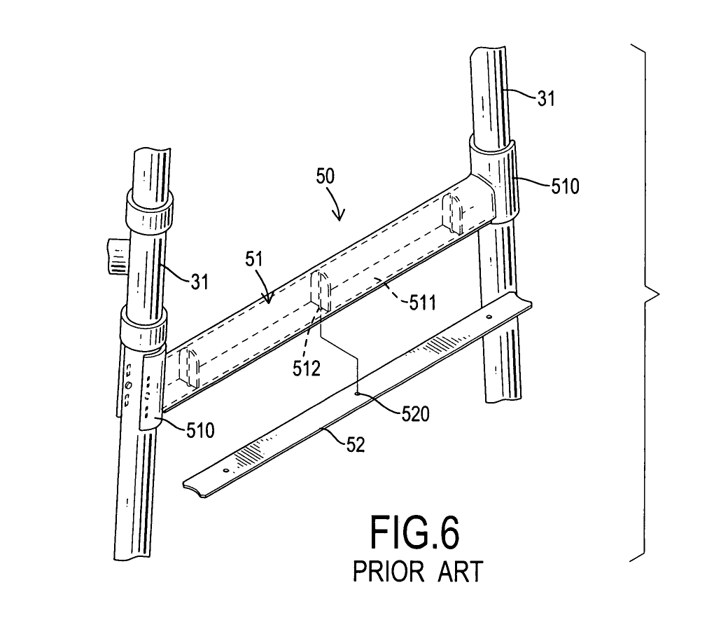

### DETAILED DESCRIPTION OF THE PREFERRED EMBODIMENT

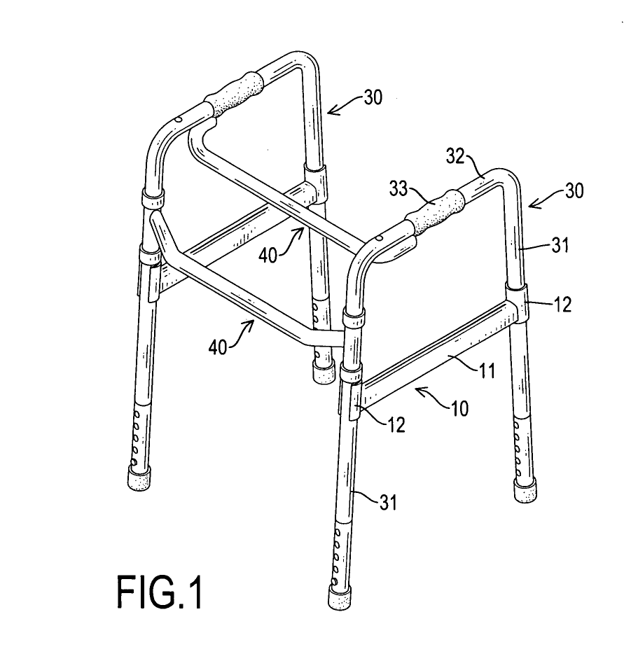

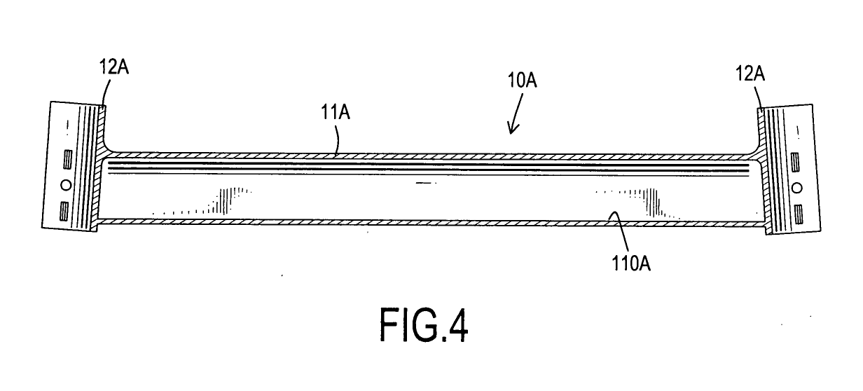

With reference to FIGS. 1 and 4, two braces (10, 10A) in accordance with the present invention are used on a walker having two side frames (30) and two crossbars (40), and each brace (10, 10A) is made of plastic and has a body (11, 11A) and two mounting clamps (12, 12A).

Each side frame (30) is U-shaped and has a handrail (32), two legs (31), a grip (33) and a brace (10, 10A).

The handrail (32) has two ends.

The legs (31) are formed respectively on and protrude down parallel to each other respectively from the ends of the handrail (32). Each leg (31) has an upper end, a lower end, an external surface, multiple connecting holes and multiple connecting posts. The connecting holes are formed respectively in the external surfaces of the legs (31) approximately midway between the upper and lower ends. The connecting posts are formed on and protrude from the external surface of the leg (31) adjacent to the connecting holes.

The grip (33) is mounted around the handrail (32) approximately midway between the ends of the handrail (32).

The crossbars (40) are connected securely to the side frames (30).

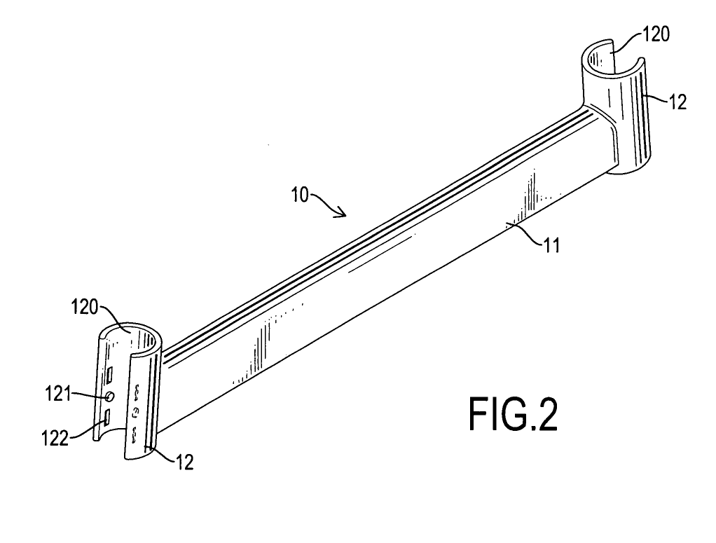

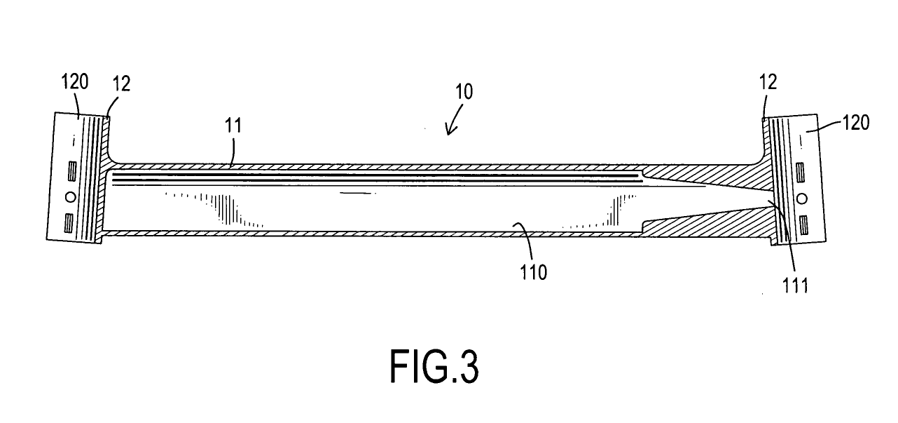

With further reference to FIGS. 2 and 3, the body (11, 11A) is hollow, is mounted between the legs (31) of the side frame (30) and has two ends, an internal cavity (110, 10A) and an optional through hole (111). The internal cavity (110, 110A) is defined longitudinally in the body (11). The through hole (111) is formed in one end of the body (11) and communicates with the internal cavity (110).

The mounting clamps (12, 12A) are cylindrical, are formed respectively on and protrude longitudinally respectively from the ends of the body (11) and are mounted respectively around the legs (31), and each mounting clamp (12) has a longitudinal mounting slot, an inner surface (120), an optional through hole, multiple mounting posts (121) and multiple mounting recesses (122).

The longitudinal mounting slot is formed diametrically opposite to the end of the body (11, 11A).

The through hole is formed through the inner surface and communicates with through hole (111) in the end of the body (12A).

The mounting posts (121) are formed diametrically opposite to each other on and protrude in from the inner surface (120) of the mounting clamp (12, 12A) and correspond respectively to and are mounted respectively in the connecting holes in a corresponding leg (31).

The mounting recesses (122) are formed in the inner surface (120) of the mounting clamp (12, 12A) adjacent respectively to the mounting posts (121) and diametrically opposite to each other and connect to the connecting posts of a corresponding leg (31).

The brace (10) as described has the following advantages.

1. The brace (10) is made of plastic. The brace (10) can be mounted directly on the walker without further processing, which will decrease the cost and time for manufacturing a brace (10).

2. Since the brace (10) is made of plastic, the brace (10) is lighter than a conventional brace (35) made of metal. Furthermore, the plastic brace (10) will not rust so users will not need to paint the conventional brace (35).

3. The body (11) and the mounting clamps (12) are molded as a single piece so no weakness will exist between pieces as a result of welding or otherwise connecting individual parts.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A brace being used on a walker, and comprising
a body being hollow and having
two ends; and
an internal cavity being defined longitudinally in the body; and
two mounting clamps being cylindrical, being formed respectively on and protruding longitudinally respectively from the ends of the body, and each mounting bracket having
a longitudinal mounting slot being formed diametrically opposite to the end of the body;
an inner surface;
multiple mounting posts being formed diametrically opposite to each other on and protruding in from the inner surface of the mounting clamp; and
multiple mounting recesses being formed in the inner surface of the mounting clamp adjacent respectively to the mounting posts and diametrically opposite to each other,
wherein the brace is made of plastic.

2. The brace as claimed in claim 1, wherein
the body has a through hole being formed in one end of the body; and
a mounting clamp further has a through hole being formed through the inner surface and communicating with the through hole in the end of the body.
